(19) United States
(12) Patent Application Publication
(10) Pub. No.: US 2021/0101459 A1
(43) Pub. Date: Apr. 8, 2021

(54) Cover for closing an opening in a vehicle body

(71) Applicant: Webasto SE, Stockdorf (DE)

(72) Inventors: Marcel Mihál, Weßling (DE); Jannick Eckerlein, Munich (DE)

(21) Appl. No.: 17/024,284

(22) Filed: Sep. 17, 2020

(30) Foreign Application Priority Data
Oct. 7, 2019 (DE) 102019126860.5

(51) Int. Cl. B60J 10/82; B60J 7/00

(52) U.S. Cl. CPC B60J 10/82; B60J 7/0007

(57) ABSTRACT

A cover for closing an opening in a vehicle body, wherein the cover has a foam edge. The foam edge may form a sealing lip which has a sealing lip base which is molded onto a main body of the foam edge, and the sealing lip furthermore has an end section, which is arranged at an end of the sealing lip opposite to the sealing lip base and is designed to have a sealing effect with a counter surface on a body-fixed edge of the opening. In the region of the sealing lip base, a groove may be formed in the foam edge to increase the mobility of the sealing lip.

The present invention relates to a cover according to the preamble of claim 1 and according to the preamble of claim 6, as well as a vehicle having such a cover according to claim 12.

A generic cover for closing an opening in a vehicle body has a foam edge. A corresponding cover can be used to solidly close an opening in a vehicle body, for example a vehicle roof, or to alternately open and close such an opening.

In known covers, plugged or adhesively-bonded seals are provided on the cover in order to achieve a sealing effect between the cover and the vehicle body (or other components of the roof). The provision of separate plugged or adhesively-bonded seals is comparatively costly and complex to assemble. Known covers are provided with a foam edge, on which the seal is fastened. Thus, when producing a corresponding cover, a main body of the cover, such as a transparent pane, first has to be provided with a foam edge. In a next step, a circumferential seal is attached to the foam edge. This structure made up of multiple components is relatively complex and costly.

The object of the present invention is to provide a cover in which the production costs are reduced and the sealing effect is nonetheless improved.

This object is achieved by a cover according to the characterizing part of claim 1 and by a cover according to the characterizing part of claim 6. This object is furthermore achieved by a vehicle having a corresponding cover according to claim 12.

In a cover according to claim 1, according to the invention the foam edge itself forms a sealing lip, which has a sealing lip base which is molded onto a main body of the foam edge, and the sealing lip furthermore has an end section, which is arranged on an end of the sealing lip opposite to the sealing lip base and is designed to have a sealing effect with a counter surface on a body-fixed edge of the opening. According to the invention, a groove is formed in the foam edge in the area of the sealing lip base.

In an alternative cover according to the invention according to claim 6, the foam edge forms a sealing lip which has a sealing lip base which is molded onto a main body of the foam edge, and the sealing lip also has an end section which is arranged on an end of the sealing lip opposite to the sealing lip base and is designed to have a sealing effect with a counter surface on a body-fixed edge of the opening. The main body of the foam edge has an edge surface, which forms an edge of the cover and is aligned essentially perpendicular to a main surface of the cover, wherein the sealing lip base is arranged on a lower side of the foam edge and offset in relation to the edge surface toward the center of the main surface.

A cover according to the invention offers the advantage that due to the one-piece embodiment of foam edge and sealing lip, the production costs are reduced, since the sealing lip is implemented simultaneously with the foaming of the cover.

Because a groove is formed in the foam edge in the area of the sealing lip base, the sealing lip is furthermore arranged more movably on the foam edge. In the region of the groove, the targeted weakening of the material by the groove forms a solid body joint, since the groove reduces the cross section in the region of the sealing lip base. The sealing lip can thus be moved more easily relative to the base body by an elastic deformation of the material of the foam edge (for example a PU foam) when it has a sealing effect with the body-fixed edge of the opening. The sealing effect is thus improved. The fact that the sealing lip can be optimized with regard to its acoustic insulation is particularly advantageous here, for example, by being able to have a reinforced cross section or by being able to use a more rigid material overall for the foam edge than in the case of a foam edge without such a groove. This offers particular advantages in designs in which a greater distance is desired between the cover itself and the body-fixed edge of the opening. One example of this is a cover which is provided as a fixed glazing of an opening in a vehicle body and a sliding cover is arranged adjacent, for example, in front of the fixed glazing, for alternately opening and closing a further opening or an adjacent region of the opening in the vehicle body. Such a sliding cover requires a greater distance between the cover edge and the adjacent regions of the vehicle body to provide installation space for a displaceable cover mechanism and hollow-chamber seals. If this distance of the cover edge to adjacent regions of the vehicle body is also to be maintained in the region of the fixed roof glazing for optical reasons, the sealing lip has to close a comparable distance to the body-fixed edge of the opening to form a seal in the region of the fixed glazing. Such a longer sealing lip can reduce the acoustic sealing effect in known solutions.

By providing a groove in the region of the sealing lip base in the foam edge, the sealing lip can advantageously be made more rigid overall, which improves the acoustic performance, and its mobility can nevertheless be adjusted via the groove. The sealing effect is thus deliberately improved and the assembly forces are also reduced. A required distance to adjacent body-fixed regions or to the body shell of the body can thus be maintained without having to compromise on the sealing effect.

Furthermore, the position of the sealing lip is settable in a direction transverse to and along the longitudinal alignment of the sealing lip by elastic deformation without negatively affecting the required distance from the shell or from the body-fixed edge of the opening. Even in the case of larger tolerances, the sealing lip does not protrude beyond the body-fixed edge of the opening, but rather can be bent away laterally or displaced along the direction of its longitudinal extension without greater application of force.

Corresponding advantages also result from a cover according to claim 6 or from a vehicle having a cover according to the invention according to claim 12, respectively.

Advantageous designs of the present invention result from the dependent claims.

In a first particularly preferred design of the present invention, the groove is arranged in the sealing lip base or in the main body or is formed by a transition region from the main body to the sealing lip base. This offers the advantage that the sealing lip is designed to be particularly movable.

The groove is preferably formed in such a way that it increases the mobility of the sealing lip with regard to elastic deformation and pivoting of the end section in parallel to the counter surface.

In a further preferred design of the invention, the main body of the foam edge has an edge surface which forms an edge of the lid and is aligned essentially in parallel to the counter surface and which, when the opening is closed, is spaced apart from it. The groove is formed as an undercut in the edge surface and/or between the edge surface and the end section.

The sealing lip preferably extends essentially perpendicular to the edge surface and parallel to a main surface of the cover and towards the counter surface.

An embodiment is particularly preferred in which the sealing lip base is arranged on one side of the foam edge that faces toward the vehicle interior.

In one embodiment, in which the cover is designed to close a roof opening, the sealing lip extends essentially in a horizontal direction.

Particularly preferably, the sealing lip first extends away from the base body in the direction of the interior of the vehicle body, and is then curved in the region of the sealing lip base so that it extends further essentially in parallel to a main surface of the cover and is oriented towards the counter surface.

If a groove is provided, the sealing lip preferably forms at least two mutually perpendicular delimitation surfaces of the groove in the region of its curvature.

In a closed position of the cover, the foam edge preferably only has a sealing effect with the counter surface by means of its sealing lip.

In the following, the invention is explained in greater detail by way of example on the basis of the figure.

In the figure:

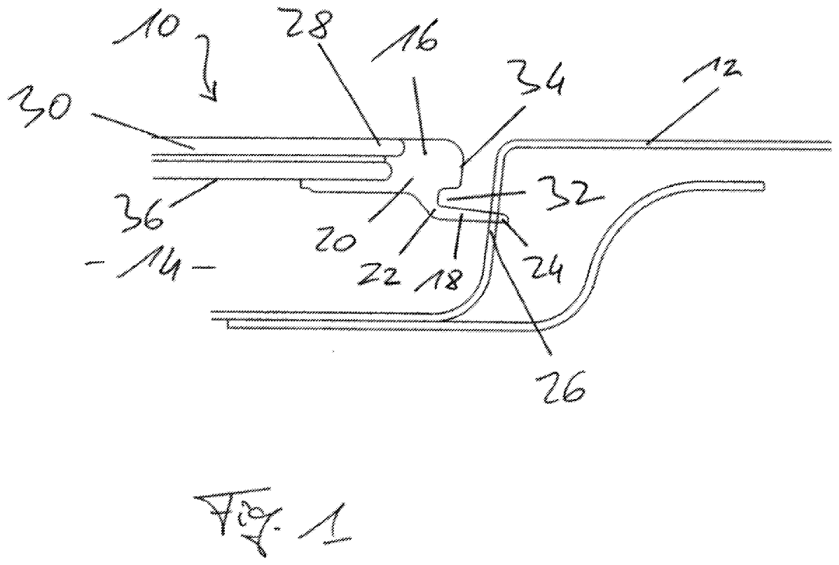

FIG. 1 shows a cover according to the invention in a schematic cross-sectional view.

FIG. 1 shows a cover 10 for closing a roof opening 14 in a vehicle body 12, wherein the cover 10 has a foam edge 16. The foam edge 16 forms a sealing lip 18 which has a sealing lip base 22 which is molded onto a main body 20 of the foam edge 16. The sealing lip 18 also has an end section 24 which is arranged on an end of the sealing lip 18 opposite to the sealing lip base 22 and is designed to have a sealing effect with a counter surface 26 on a body-fixed edge of the roof opening 14.

In the area of the sealing lip base 22, a groove 32 is formed in the foam edge 16, which is used to increase the mobility of the sealing lip 18. In the elastic material of the foam edge 16, the groove 32 represents a deliberate material weakening, whereby a solid body joint is formed in the area of the sealing lip base 22, around which the sealing lip 18 can be pivoted vertically. The axis of rotation is in a direction parallel to an edge 28 of the cover 10 here. The cover 10 furthermore has a transparent pane 30, which is provided with the foam edge 16 in the edge regions.

The cover 10 of FIG. 1 is a cover of a fixed glazing, which means that in the installed state, the cover 10 is incorporated fixedly in the vehicle body 12. An adhesive (not shown in greater detail) or an adhesive bead, which fixedly connects the foam edge 16 to the vehicle body 12, can be used for installation. Such an adhesive can be incorporated, for example, into the gap shown between the foam edge 16, in particular in an edge surface 34 of the foam edge 16, and adjacent regions of the vehicle body 12 below the sealing lip 18.

The foam edge 16 is foamed or extruded on in the region of the cover edge 28 and can enclose the cover 10 or the pane 30 along the entire outer edge. The sealing lip 18 extends essentially in a horizontal direction away from the cover 10 in the direction of adjacent regions of the vehicle body 12. The sealing lip 18 is thus oriented horizontally essentially in parallel to a main surface 36 of the cover 10 or the pane 30.

The sealing lip 18 is foamed onto a main body 20 of the foam edge 16 in the region of a sealing lip base 22 and is formed simultaneously with the formation of the foam edge 16 and its foaming on the pane 30 by means of an injection mold. In the region of the sealing lip base 22, the groove 32 is provided in the foam edge 16 in order to increase the mobility of the sealing lip 18 with respect to elastic deformation. Although the foam edge 16 already consists of an elastic material such as a PU foam, the mobility of the sealing lip 18 is thus deliberately improved. Since the groove 32 represents an undercut in the foam edge 16, a slide is provided in the corresponding mold when foaming or injection molding the foam edge 16 onto the pane 30 in order to be able to remove the foamed cover 10 from the injection mold.

In the installed state of the cover 10 in the roof opening 14 of the body 12, an end section 24 of the sealing lip 18 is supported on a counter surface 26 of the vehicle body 12. FIG. 1 schematically shows, in cross section through the vehicle body 12, the state of the sealing lip 18 without interaction of the end section 24 with the counter surface 26. In fact, in the installed state of the cover 10, the sealing lip 18 is pivoted upward and/or displaced away from the counter surface 26 (to the left in the direction of the center of the main surface 36 of the cover 10 in FIG. 1) by the end section 24 hitting the counter surface 26. The pivoting or displacement takes place around a solid body joint, which is formed by the groove 32 in the sealing lip base 22.

By providing the groove 32 in the foam edge 16 in the region of the sealing lip base 22, the mobility of the sealing lip 18 is significantly increased, whereby, for example, the installation forces when inserting the cover 10 into the roof opening 14 are reduced. At the same time, the cross section of the sealing lip 18 in the area between the sealing lip base 22 and the end section 24 can be enlarged without excessive installation forces occurring. Because the sealing lip 18 can be made comparatively solid, it can cover a greater distance between the edge surface 34 and the vehicle body 12 in the horizontal direction without reducing the sealing effect with respect to noise, airflow, or weather influences. In particular, the distance between the cover edge 28 and in particular the edge surface 34 of the foam edge 16 and adjacent regions of the vehicle body 12 in the horizontal direction can thus be better adapted to corresponding design specifications. This offers the advantage, for example, that the horizontal distance between the edge surface 34 and the vehicle body 12 can be dimensioned in such a way that it can be adapted to a corresponding distance from an adjacent displaceable cover (not shown in greater detail) of a sliding roof, which has to have a specified minimum width, in order to be able to guide a cover mechanism which guides the movable cover in the longitudinal direction of the vehicle (perpendicular to the cross section of FIG. 1), between the displaceable cover and adjacent regions of the vehicle body 12.

Another advantage of the improved mobility of the sealing lip 18 is the fact that manufacturing tolerances that result in an enlarged or reduced distance between the cover 10 and the vehicle body 12 can be better compensated for.

As already explained, the groove 32 is designed as an undercut in the foam edge 16. The sealing lip 18 extends below the groove 32 and adjoining it away from the main body 20 of the foam edge 16 in the horizontal direction towards the counter surface 26 of the vehicle body 12. The sealing lip 18 is arranged essentially below the main surface 36 of the cover 10 or below the pane 30 of the cover 10. This arrangement is implemented by the sealing lip base 22, which initially extends perpendicularly or obliquely downward from the main surface 36 and has a curvature which is designed such that the sealing lip 18 is oriented in a substantially horizontal direction, in particular in the region after the sealing lip base 22 and the end section 24 of the sealing lip 18. The curved region of the sealing lip base 22 thus forms a lower delimitation and a vertical section of the groove 32, while a further (upper) delimitation of the groove 32 is formed by the main body 20 of the foam edge 16. This geometry has the result that the sealing lip base 22 is arranged on the lower side of the foam edge 16 and offset in relation to the edge surface 34 towards the center of the base surface 36.

### LIST OF REFERENCE NUMERALS

10 cover
12 vehicle body
14 roof opening
16 foam edge
18 sealing lip
20 main body
22 sealing lip base
24 end section of the sealing lip 18
26 counter surface
28 cover edge
30 pane
32 groove
34 edge surface
36 main surface

1. A cover for closing an opening in a vehicle body, wherein the cover has a foam edge,
and wherein
the foam edge forms a sealing lip which has a sealing lip base which is molded onto a main body of the foam edge, and the sealing lip furthermore has an end section, which is arranged at an end of the sealing lip opposite to the sealing lip base and is designed to have a sealing effect with a counter surface on a body-fixed edge of the opening, and
a groove is formed in the foam edge in the area of the sealing lip base.

2. The cover as claimed in claim 1, wherein the groove is arranged in the sealing lip base or in the main body or is formed by a transition region from the main body into the sealing lip base.

3. The cover as claimed in claim 1, wherein the groove is designed in such a way that it increases the mobility of the sealing lip with respect to elastic deformation and pivoting of the end section in parallel to the counter surface and/or with respect to a displacement of the sealing lip in a direction away from the counter surface.

4. The cover as claimed in claim 1, wherein the main body of the foam edge has an edge surface, which forms an edge of the cover and is oriented essentially in parallel to the counter surface and, when the opening is closed, is arranged spaced apart from it, and the groove is formed as an undercut in the edge surface and/or between the edge surface and the end section.

5. The cover as claimed in claim 4, wherein the sealing lip extends essentially perpendicular to the edge surface and in parallel to a main surface of the cover and toward the counter surface.

6. A cover for closing an opening in a vehicle body, wherein the cover has a foam edge,
wherein
the foam edge forms a sealing lip which has a sealing lip base which is molded onto a main body of the foam edge, and the sealing lip furthermore has an end section, which is arranged at an end of the sealing lip opposite to the sealing lip base and is designed to have a sealing effect with a counter surface on a body-fixed edge of the opening, and
the main body of the foam edge has an edge surface which forms an edge of the cover and is oriented essentially perpendicular to a main surface of the cover, and wherein
the sealing lip base is arranged on a lower side of the foam edge and offset in relation to the edge surface towards the center of the base surface.

7. The cover as claimed in claim 1, wherein the sealing lip base is arranged on a side of the foam edge which faces toward the vehicle interior.

8. The cover as claimed in claim 1, wherein the cover is designed to close a roof opening, and the sealing lip extends essentially in a horizontal direction.

9. The cover as claimed in claim 1, wherein the sealing lip first extends away from the main body in the direction of the interior of the vehicle body, and is then curved in the region of the sealing lip base such that it extends further essentially in parallel to a main surface of the cover and is oriented towards the counter surface.

10. The cover as claimed in claim 9 wherein the sealing lip forms at least two mutually perpendicular boundary surfaces of the groove in the region of its curvature.

11. The cover as claimed in claim 1, wherein in a closed position of the cover, the foam edge only has a sealing effect with the counter surface by means of its sealing lip.

12. A vehicle having a cover as claimed in claim 1.
